(19) United States
(12) Patent Application Publication
(10) Pub. No.: US 2006/0190356 A1
(43) Pub. Date: Aug. 24, 2006

(54) System and method for quality assurance

(76) Inventor: Yaron Nemet, Kedumim (IL)

Correspondence Address: RICHARD I. SAMUEL;GOODWIN PROCTER L.L.P, 599 LEXINGTON AVE., NEW YORK, NY, 10022, US

(21) Appl. No.: 11/291,564

(22) Filed: Dec. 1, 2005

Related U.S. Application Data
(60) Provisional application No. 60/632,623, filed on Dec. 2, 2004.

(51) Int. Cl. G06F 17/30

(52) U.S. Cl. 705/27

(57) ABSTRACT

A quality assurance method is disclosed in which individual packages are selected and grouped together according to what is to be sent to a specific receiver; the method includes providing a group of individual packages at least a plurality of which have visual identifiers thereon; a Pick List in the form of an electronic record identifying what ones of the group of individual packages should be is also provided; the group of individual packages are imaged to provide an electronic image suitable for further processing, the electronic image includes some or all of the visual identifiers; the electronic image is processed to extract information from the some or all of the visual identifiers relating to the individual packages in the group to provide an Electronic Pick List; and the Electronic Pick List is correlated with the Pick List to provide information relating to the relationship between the group of individual packages and what ones of the group of individual packages should be. The disclosed method also includes the step of correcting the relationship between the group of individual packages and what ones of the group of individual packages should be to provide a corrected group of individual packages. The disclosed quality assurance method also includes the step of sending the corrected group of individual packages to the receiver at a remote location. The disclosed quality assurance method also includes the steps of: providing a remote Pick List in the form of a second electronic record identifying what ones of the group of individual packages should be; imaging the corrected group of individual packages at the remote location to provide a remote electronic image suitable for further processing, the remote electronic image including some or all of the visual identifiers; processing the remote electronic image to extract information from the some or all of the visual identifiers relating to the individual packages in the corrected group to provide a remote Electronic Pick List; and correlating the remote Electronic Pick List with the remote Pick List to provide information relating to the relationship between the corrected group of individual packages and what ones of the group of individual packages should be.

### FIELD OF THE INVENTION

The present invention relates to quality assurance and particularly to quality assurance in a pick list system.

### BACKGROUND OF THE INVENTION

In a distribution center, individual packages get selected and grouped together according to a list of what is to be sent to a specific receiver. Such group of packages may be wrapped together and/or may be sent on or in one or more pallets or boxes. Such a list is known as a “pick list”. The receiver can also define a set of rules about the contents of such a group of packages.

When the group of packages arrives at the receiver, the receiver usually checks the packages against the pick list and/or the set of rules. If the group of packages matches the pick list and the set of rules, the receiver is satisfied. If the group of packages does not match the pick list and set of rules, the distributor may be fined by the receiver or it may be costly for the distributor to correct the error. For example, if the order was for a specific amount of tomatoes but cucumbers were received instead, the distributor may have to replace the cucumbers with the requested tomatoes. The returned cucumbers may no longer be fresh enough to send to a different customer.

### BRIEF DESCRIPTION OF THE INVENTION

The present invention, in one embodiment, relates to a quality assurance method in which individual packages are selected and grouped together according to what is to be sent to a specific receiver; the method includes providing a group of individual packages at least a plurality of which have visual identifiers thereon; providing a Pick List in the form of an electronic record identifying what ones of the group of individual packages should be; imaging the group of individual packages to provide an electronic image suitable for further processing, the electronic image including some or all of the visual identifiers; processing the electronic image to extract information from the some or all of the visual identifiers relating to the individual packages in the group to provide an Electronic Pick List; and correlating the Electronic Pick List with the Pick List to provide information relating to the relationship between the group of individual packages and what ones of the group of individual packages should be.

In another embodiment of the invention, the quality assurance method also includes the step of correcting the relationship between the group of individual packages and what ones of the group of individual packages should be to provide a corrected group of individual packages.

In still another embodiment of the invention, the quality assurance method also includes the step of sending the corrected group of individual packages to the receiver at a remote location.

In yet another embodiment of the invention, the quality assurance method also including the steps of: providing a remote Pick List in the form of a second electronic record identifying what ones of the group of individual packages should be; imaging the corrected group of individual packages at the remote location to provide a remote electronic image suitable for further processing, the remote electronic image including some or all of the visual identifiers; processing the remote electronic image to extract information from the some or all of the visual identifiers relating to the individual packages in the corrected group to provide a remote Electronic Pick List; and correlating the remote Electronic Pick List with the remote Pick List to provide information relating to the relationship between the corrected group of individual packages and what ones of the group of individual packages should be.

In still another embodiment of the invention, the quality assurance method also includes the step of correcting the relationship between the corrected group of individual packages and what ones of the group of individual packages should be.

In another embodiment of the invention, the remote Pick List is provided by sending the Pick List to the remote location.

In still another embodiment of the invention, the information relating to the relationship between the group of individual packages and what ones of the group of individual packages should be is provided from the electronic image together with remarks and/or marks relating thereto.

In another embodiment of the invention, the information relating to the relationship between the group of individual packages and what ones of the group of individual packages should be includes a mark indicating which of two or more individual packages in the group should be removed from the group.

In another embodiment of the invention, the quality assurance method also includes the step of correcting the relationship between the group of individual packages and what ones of the group of individual packages should be to provide a corrected group of individual packages.

In another embodiment of the invention, a system is provided comprising: a container having a multiplicity of objects thereon, wherein at least one of the multiplicity of objects has an imagable identifier affixed thereto; a container reader to image the multiplicity of objects to provide an image; and an analyzer for determining, from the image and from a user-defined description of objects that were expected to be associated with the container, if the container has the expected objects.

In another embodiment of the invention, the user-defined description comprises at least one of the following: a pick list, a set of rules and a lookup table converting identification codes embodied in the identifiers to product terms.

### DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram showing an overall method and system demonstrating this invention;

FIG. 1a is an illustration of a computer screen with a display of an image with markings thereon;

FIG. 2 is a block diagram of an exemplary quality assurance unit, constructed and operative for use in accordance with the present invention shown sensing bar codes or the like on a pallet of items;

FIG. 3 is a logical block diagram of a portion of the exemplary quality assurance unit, of FIG. 2;

FIG. 4 is an illustration of a dynamic visually sensible sensor, useful in the quality assurance unit of FIG. 1; and

FIGS. 5A, 5B, 5C, 5D and 5E are flow chart illustrations of different operations of the quality assurance unit of FIG. 1.

### DETAILED DESCRIPTION OF THE INVENTION

The aspects, features and advantages of the present invention will become better understood with regard to the following description with reference to the accompanying drawing(s). What follows are preferred embodiments of the present invention. It should be apparent to those skilled in the art that these embodiments are illustrative only and not limiting, having been presented by way of example only. All the features disclosed in this description may be replaced by alternative features serving the same purpose, and equivalents or similar purpose, unless expressly stated otherwise. Therefore, numerous other embodiments of the modifications thereof are contemplated as falling within the scope of the present invention as defined herein and equivalents thereto.

In the following detailed description, numerous specific details are set forth in order to provide a thorough understanding of the invention. However, it will be understood by those skilled in the art that the present invention may be practiced without some of these specific details. In other instances, well-known methods, procedures, and components have not been described in detail so as not to obscure the present invention.

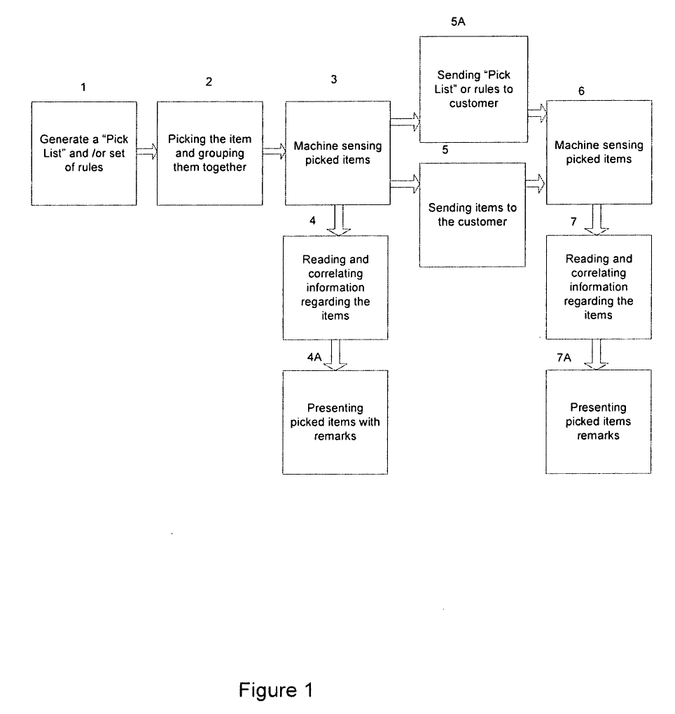

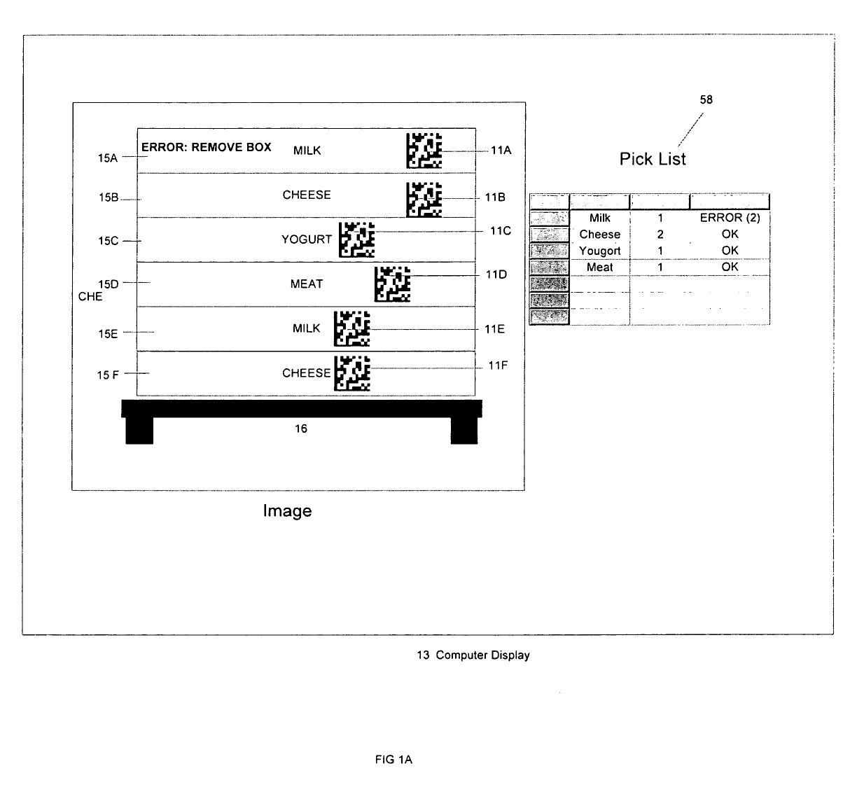

Referring now to FIG. 1 we see a block diagram showing an overall method and system demonstrating this invention which may be used at a distribution center. In box 1 a “Pick List” and/or a set of rules is generated. A “Pick List” can be generated in a number of ways such as by merely generating a list that has a desired set of items to be picked from a larger group of items to be shipped to a receiver. The set of rules can be generated by setting forth a required relationship between items to be picked. Step 2 is to pick the items from a store and group them together. Most if not all of the items in the store have visual or r.f. identifiers on them. These identifiers can be conventional bar codes. Another way of generating a “Pick List” is by picking items from the store and placing them in a group and making a list of the items so picked. In this case steps 1 and 2 are reversed. In either case the result is a group of items and a list identifying what those items are or should be and/or a set of rules relating to the relationship between items picked. This “Pick List” and/or set of rules has traditionally been on paper but can be in any form such as an electronic record for display or further use in an electric process such as will be described below.

At step 3 the picked items are machine sensed. This sensing can done by a CCD or CMOS camera or other sensor. The result of the machine sensing step is electronic data suitable for further processing.

In step 4 the electronic data is processed to extract as much information as possible relating to the items in the group to provide an “Electronic Pick List”. The “Electronic Pick List” is correlated with the original “Pick List” and/or set of rules to provide information to a system user.

In step 4a the information is provided to a system user as an image of the picked items with marks or remarks relating thereto. See, for example, FIG. 1a.

Step five involves sending the picked items to a receiver at a remote location who may repeat steps 3, 4 and 4a at 6, 7 and 7a respectfully.

In step 5a the Pick List or Rules are optionally sent to the receiver.

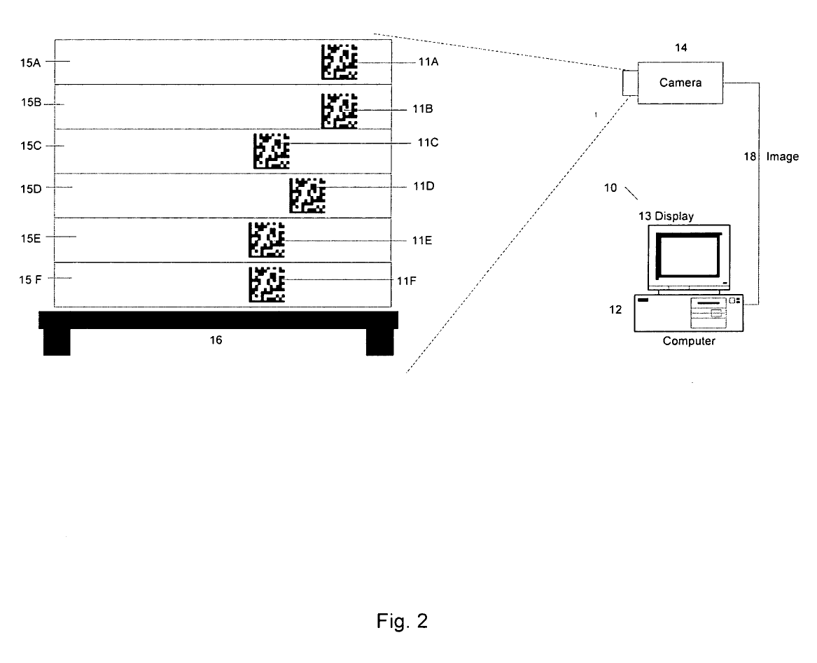

Reference is now made to FIG. 2 which shows a box or pallet 16, having items 15a 15f thereon. Each of the items 15a-15f have imageable identifiers 11a-11f mounted thereon of course r.f. identifiers can be used. A QA unit 10, is also shown which comprises a camera 14 to provide images 18 in electronic form on an output cable to a QA analyzer 12 which may be a computer. In operation the camera 14 may image items 15a-15f on the box or pallet 16 and provides an image 18 thereof in electronic form on an output cable. The QA analyzer 12 receives and analyzes the image 18 provided on the cable and decodes identifiers 11a-11f and determines if container 16 is correctly loaded. The QA unit 10 also may includes a display 13 to display information relating to the analyzed images, and if appropriate indications of the location(s) of incorrectly loaded items, see FIG. 1a. For example, if there should be one of a particular item but there are two, one of them with be an incorrectly loaded item. Let's assume that one of the two items are at the bottom of a pile and the other item is on top. The system will only mark the top item because only on of the two items is incorrect and the top one is easier to remove.

The display 13 can be, but need not be part of the computer which serves as the QA analyzer 12. The information relating to the analyzed images may be presented in many forms including graphic images, schematic images, text, tables, voice or combinations of the above. As will be seen, not all of the items such as items 15a-15f need have identifiers such as imageable identifiers 11a-11f to practice certain embodiments of this invention.

Personnel or equipment at the distribution center may use the information generated by the QA analyzer 12 to correct errors made in packing, before the incorrect items are sent to the receiver. This may save significantly on fines and reduce the number of errors that the distributor may have to correct. It may also save time and money for the receiver.

QA unit 10 may image any suitable type of container 16. For example, container 16 may be, but is not limited to, a flat, pallet, dolly, container or truck or a set thereof. Container 16 may hold a multiplicity of cartons that are to be transported, distributed or otherwise tracked or counted for a variety of purposes, including quality assurance and inventory control. Cartons may be stacked on or in container 16.

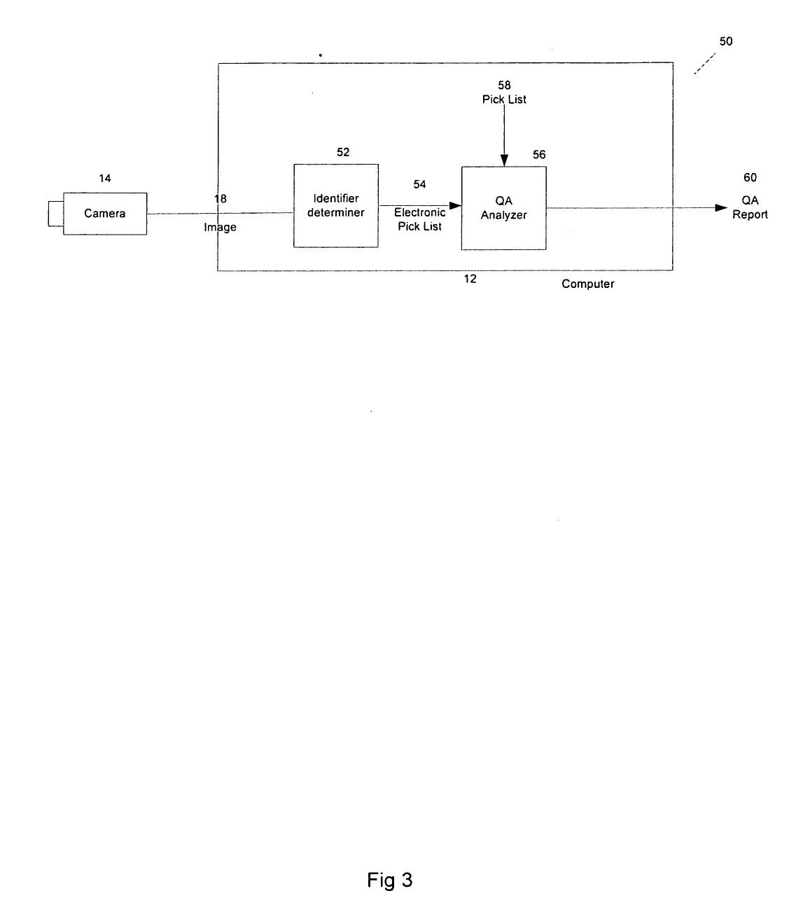

Camera 14 may be any suitable unit which may image container 16 to provide the image 18. For example, it may be the camera disclosed in PCT publication WO/060626 A2, the entire publication is incorporated herein by reference. The camera 14 feeds an identifier determiner 52, see FIG. 3. Camera 14 may be any camera or group of cameras capable of viewing container 16 with enough resolution and may with identifier determiner 52 determine which identifiers are found.

Identifier determiner 52 searches image 18 for identifiers 11, for example, in accordance with PCT publication WO/060626 A2. During the search, imager determiner 52 may find a plurality of imageable identifiers in image 18 and may note their coordinates. Identifier determiner 52 may then determine the identification code of each of the imageable identifiers 11, which indicate the identity or type of each carton that may be located on or in container 16. Based on this information, imager determiner 52 may then produce an Electronic Pick List 54 and provide it to QA analyzer 56.

In one embodiment, Electronic Pick List 54 may comprise a multiplicity of records, each comprising an identifier, its coordinates in the image, its physical location (i.e. the then current location of camera 14) and its physical size, which may be calculated based on the size of the identifier and information about the optics of camera 14.

QA analyzer 56 may analyze Electronic Pick List 54 with respect to a pick list 58 and/or to a set of rules. Pick list 58 may be a list of items specified by the receiver to be on or in container 16 and may include several parameters and/or conditions. These may include, but are not limited to, the number of cartons, weight of each carton, weight of the full container 16, dimensions of each carton and a temperature range allowed for each carton, according to the specification of an individual receiver. Pick list 58 may contain a list of codes of items to be included in container 16 or it may contain a list of the names of the items themselves. For the latter, QA analyzer 56 may utilize a lookup table (LUT), which may translate between identification codes and the names of the items they represent (such as “code 138 means sugar”).

In accordance with the present invention, QA analyzer 56 may compare Electronic Pick List 54 against pick list 58. After QA analyzer 56 has compared Electronic Pick List 54 against pick list 58, QA analyzer 56 may produce a QA report 60, which may describe the differences between the expected values of pick list 58 and the actual values of Electronic Pick List 54. In addition, QA analyzer 56 may add markings to image 18 to indicate which identifiers 11 belong in container 16 and which do not. See, for example, FIG. 1a. Other markings may also be included, such as which items should be removed and which no longer meet the predefined parameters and conditions.

Referring in particular to FIG. 1a. we see the computer screen 13 with an image of the container 16 which is provided from the electronic image 18 having both a mark and remarks thereon and a pick list showing the results of the process of this invention. As seen in the pick list there should only be one milk in the container. As we see in the image there are two milks, one as item 15a and the second as 15e. In the Pick List a remark in made of ERROR. The remaining items in the Pick List correspond to the items in the container 16 and are therefore marked OK. On the image only item 15a is marked by having language adjacent thereto saying ERROR. The remark also says REMOVE BOX. Note that item 15e is also milk and could also have been marked instead of item 15a, but the system has determined that 15a being at the top of the pile is easier to remove that item 15e so only one milk is left in accordance with the Pick List.

Referring again to FIG. 3, QA analyzer 56 may also compare Electronic Pick List 54 to a set of rules. A set of rules may specify constraints to be used for all receivers of items, or for only a specific one. For example, the rules may specify that, in a container of 20 items, if one item is incorrect, the shipment should be sent without correcting the one item. This may be done because it may be more costly to spend resources on exchanging the incorrect item rather than paying the fine for shipping one incorrect item.

Other rules may specify that certain types of items should be included together with other types, such as “for every carton of pants there should be a carton of matching shirts” or “sock cartons are allowed not to have identifiers”.

QA unit 10 may be located in any one of a number of locations, depending on the operation of the distribution center. For example, it may be affixed to a truck or mounted on a wall at a fixed known location. It may be a mobile device with wheels such that it may be transported easily, or it may be a handheld device.

The imageable identifiers 11 may be Data Matrix labels, two-dimensional barcodes, multiple barcodes, standard codes, text, and the like, and may be in black and white, or in color. The imageable identifiers may also include a dynamic sensor, which may be analyzed by QA analyzer 12. Such a visually dynamic sensor may be included as part of any of the imageable identifiers 11.

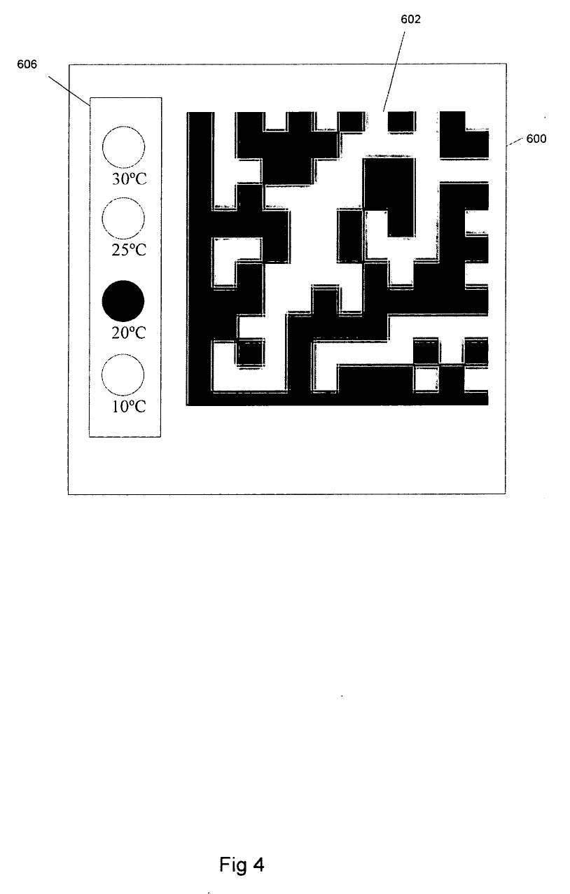

Reference is now briefly made to FIG. 4, which is a simplified illustration of an exemplary visually sensible, dynamic sensor which QA unit 10 may process.

As seen in FIG. 4, a multi-parameter sensor assembly 600 may be provided, including a location sensor 602, and a temperature sensor 606. The multi-parameter sensor assembly 600 may also include a humidity sensor and an inertial sensor. The QA unit 10 may store extreme values of the various parameters and may display them in a suitable form on a dynamic identification indicator, such as display 13 in FIG. 2.

It will be appreciated that QA unit 10 may also be operable to receive additional parameters, by any suitable method, such as a wired, wireless input device or r.f. sensor.

Visually sensible output sensors may include, but are not limited to, the following environmental sensors:

TILTWATCH tilt indicator and SHOCKWATCH shock indicator, commercially available from Switched On I & T Services of Braeside, Victoria, Australia;

Humidity Indicator Cards and Plugs commercially available from SudChemie Performance Packaging of Beten, New Mexico, USA; and

COLDMARK and WARMMARK temperature history indicators, commercially available from IntroTech BV of Loenen, the Netherlands.

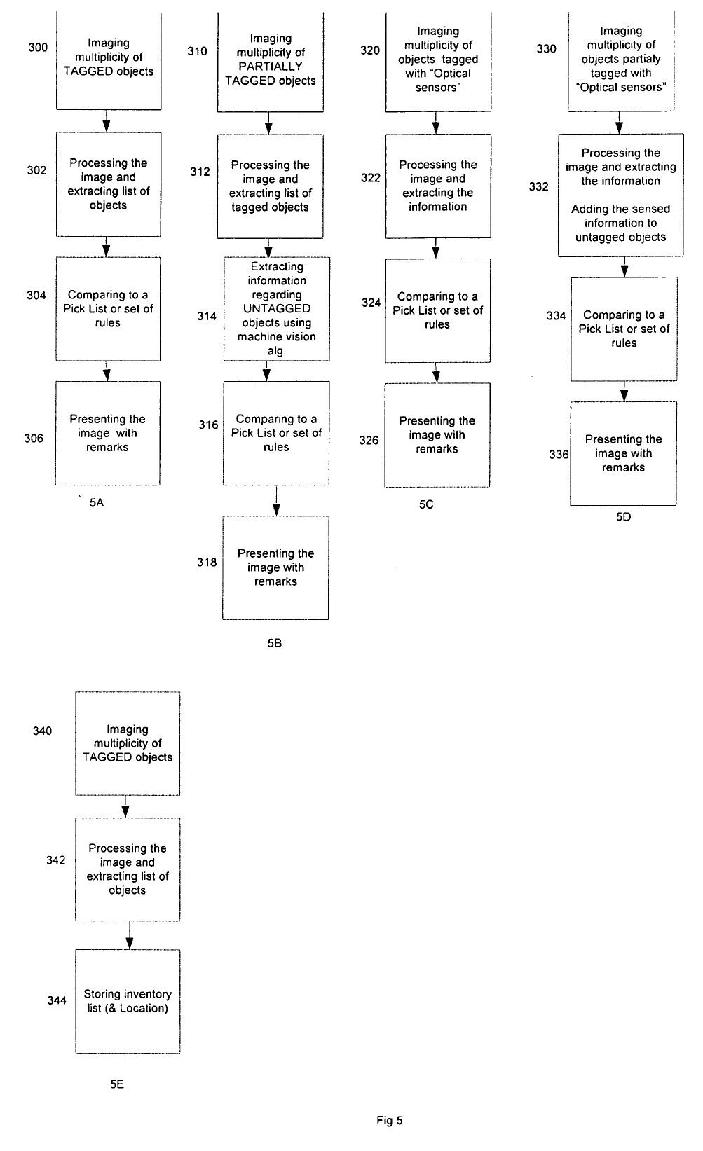

Reference is now made to FIGS. 5A, 5B, 5C, 5D and 5E, each of which shows one of five flow charts for five scenarios that can be performed by the present invention.

In FIG. 5A, camera 14 of FIGS. 2 and 3 may image (step 300) a multiplicity of objects, all of which may be tagged with some type of imageable identifier 11. Identifier determiner 52 may then process (step 302) the image received from camera 14 and may extract a list of items present in container 16. QA analyzer 12 may then receive Electronic Pick List 54 and may compare (step 304) Electronic Pick List 54 to pick list 58 and/or to the set of rules. Finally, in according with an embodiment of the present invention, display 13 may display (step 306) a processed image, indicating whether Electronic Pick List 54 meets the rules and/or pick list 58.

In accordance with a preferred embodiment of the present invention, the QA report may also show that a carton expected by pick list 58 is missing, or incorrect according to what was specified by pick list 58. Additionally, QA analyzer 12 may calculate if there is a duplicate of an item specified by pick list 58. QA analyzer 12 may also calculate which of the two or more duplicate items may be more easily removed from the container, based on a variety of parameters. These parameters may include the weight, size or location of the duplicate item and its neighboring items.

In FIG. 5B, camera 14 may image (step 310) a multiplicity of objects, at least some of which may be tagged with some type of imageable identifier. Identifier determiner 52 may then process (step 312) the image received from camera 14 and extract a list of tagged items present in container 16. In accordance with an embodiment of the present invention, QA analyzer 12 may also determine (step 314) the presence of untagged items in container 16 and may also determine other information about the untagged items.

In accordance with an embodiment of the present invention, imageable determiner 52 may deduce that there are six cartons on container 16, despite imageable determiner 52 being able to only find five imageable identifiers. QA analyzer 12 may utilize the location information of the five identifiers found to determine the presence of the untagged carton.

Other methods of determining the number of cartons may include, but are not limited to, checking the number of pre-defined shapes (squares, rectangles, hexagons, etc) and/or checking for patches of color.

QA analyzer 12 may utilize the rule that, regardless of whether there is an imageable identifier mounted thereon, each of the cartons may be the same size and thus, are located at generally equal distances from each other. If an imagable identifier is present on a carton, the imagable identifier should be roughly equidistant from the imagable identifiers affixed to the cartons above and below it.

If a carton, is lacking an imagable identifier, QA analyzer 12 may still be able to discern its existence, as follows. If a distance “A” between an identifier on a carton and an identifier on another carton is generally equal to a distance “C” and a distance “D” between an identifier on two other cartons is the same, but the distance “B” between an identifier on a second carton and an identifier on a detected adjacent carton may be generally twice as large as distances “A”, “C” and “D”, it may be deduced that an additional carton exists, and may be sitting between two of the cartons with the larger spacing.

Returning to FIG. 5B, after QA analyzer 12 has identified untagged objects, QA analyzer 12 may compare (step 316) information about tagged and untagged objects against pick-list 58 or the set of rules. Finally, in accordance with an embodiment of the present invention, display 13 may display (step 318) an image with remarks, describing whether Electronic Pick List 54 meets the set of rules and/or pick list 58.

In FIG. 5C, camera 14 may image (step 320) a multiplicity of objects in container 16, all of which may be tagged with visually dynamic sensors from a multi-parameter sensor. Identifier determiner 52 may then process (step 322) the image and may extract information about the tagged objects. QA analyzer 12 may then receive the information and may compare (step 324) the information about the tagged objects against a preset list of desired parameters. For example, one parameter may be a maximum temperature that the item may be allowed to have been at.

Finally, in accordance with an embodiment of the present invention, display 13 may display (step 326) an image with remarks, describing whether Electronic Pick List 54 meets the set of rules and/or pick list 58.

In FIG. 5D, camera 14 may image (step 330) a multiplicity of objects in container 16, at least some of which may be tagged with visually dynamic sensors from a multi-parameter sensor assembly. Identifier determiner 52 may then process (step 332) the image and QA analyzer 12 may extract information about tagged and untagged objects. QA analyzer 12 may extract the information about the untagged items utilizing the methods described above. Moreover, QA analyzer 12 may apply information from at least one dynamic sensor from the sensor assembly attached to at least one item in container 16 to the remaining items in container 16. This may assume that, if the item having the dynamic sensor went through a certain state (i.e. an extreme temperature, humidity or a fall), then all the others items in the container also went through that state.

QA analyzer may then receive the information and may compare (step 234) the information about the tagged and untagged objects against a preset list of desired parameters. Finally, in accordance with an embodiment of the present invention, display 13 may display (step 336) an image with remarks, describing whether Electronic Pick List 54 meets the set of rules and/or pick list 58.

In FIG. 5E, camera 14 may image (step 340) a multiplicity of tagged objects. Identifier determiner 52 may process (step 342) the image and may extract Electronic Pick List 54. In this embodiment, container 16 also has a tag and that tag includes information regarding the current location of container 16. Rather than using Electronic Pick List 54 for QA purposes, QA analyzer 12 may generate an inventory list, comprising the list of objects and the location indicated from the tag on container 16. QA analyzer may store (step 344) the inventory list for future use.

While certain features of the invention have been illustrated and described herein, many modifications, substitutions, changes, and equivalents will now occur to those of ordinary skill in the art.

1. A quality assurance method in which individual packages are selected and grouped together according to what is to be sent to a specific receiver; said method including:
providing a group of individual packages at least a plurality of which have visual identifiers thereon;
providing a Pick List in the form of an electronic record identifying what ones of said group of individual packages should be;
imaging said group of individual packages to provide an electronic image suitable for further processing, said electronic image including some or all of said visual identifiers;
processing said electronic image to extract information from said some or all of said visual identifiers relating to the individual packages in said group to provide an Electronic Pick List; and
correlating said Electronic Pick List with said Pick List to provide information relating to the relationship between said group of individual packages and what ones of said group of individual packages should be.

2. The quality assurance method as defined in claim 1 also including the step of correcting the relationship between said group of individual packages and what ones of said group of individual packages should be to provide a corrected group of individual packages.

3. The quality assurance method as defined in claim 2 also including the step of sending said corrected group of individual packages to said receiver at a remote location.

4. The quality assurance method as defined in claim 3 also including the steps of:
providing a remote Pick List in the form of a second electronic record identifying what ones of said group of individual packages should be;
imaging said corrected group of individual packages at said remote location to provide a remote electronic image suitable for further processing, said remote electronic image including some or all of said visual identifiers;
processing said remote electronic image to extract information from said some or all of said visual identifiers relating to the individual packages in said corrected group to provide a remote Electronic Pick List; and
correlating said remote Electronic Pick List with said remote Pick List to provide information relating to the relationship between said corrected group of individual packages and what ones of said group of individual packages should be.

5. The quality assurance method as defined in claim 4 also including the step of correcting the relationship between said corrected group of individual packages and what ones of said group of individual packages should be.

6. The quality assurance method as defined in claim 4 wherein said remote Pick List is provided by sending said Pick List to said remote location.

7. The quality assurance method as defined in claim 1 wherein said information relating to the relationship between said group of individual packages and what ones of said group of individual packages should be is provided from said electronic image together with remarks relating thereto.

8. The quality assurance method as defined in claim I wherein said information relating to the relationship between said group of individual packages and what ones of said group of individual packages should be is provided from said electronic image together with a mark relating thereto.

9. The quality assurance method as defined in claim 7 wherein said information relating to the relationship between said group of individual packages and what ones of said group of individual packages should be includes a mark indicating which of two or more individual packages in said group should be removed from said group.

10. The quality assurance method as defined in claim 9 also including the step of correcting the relationship between said group of individual packages and what ones of said group of individual packages should be to provide a corrected group of individual packages.

11. The quality assurance method as defined in claim 4 wherein said information relating to the relationship between said corrected group of individual packages and what ones of said group of individual packages should be is provided from said remote electronic image together with remarks relating thereto.

12. The quality assurance method as defined in claim 11 wherein said information relating to the relationship between said group of individual packages and what ones of said group of individual packages should be includes a mark indicating which of two or more individual packages in said group should be removed from said group.

13. The quality assurance method as defined in claim 12 also including the step of correcting the relationship between said group of individual packages and what ones of said group of individual packages should be to provide a corrected group of individual packages.

14. The quality assurance method as defined in claim 4 wherein said information relating to the relationship between said group of individual packages and what ones of said group of individual packages should be is provided from said electronic image together with marks relating thereto.

15. The quality assurance method as defined in claim 4 wherein said remote Pick List is provided by sending said Pick List to said remote location.

16. The quality assurance method as defined in claim 1 wherein said information relating to the relationship between said group of individual packages and what ones of said group of individual packages should be includes information relating to individual packages with no visual identifiers.

17. The quality assurance method as defined in claim 4 wherein said information relating to the relationship between said group of individual packages and what ones of said group of individual packages should be includes information relating to individual packages with no visual identifiers.

18. A quality assurance method in which individual packages are selected and grouped together according to what is to be sent to a specific receiver; said method including:
providing a group of individual packages at least a plurality of which have visual identifiers thereon;
sending said group of individual packages to said receiver at a remote location;
providing a remote Pick List in the form of a second electronic record identifying what ones of said group of individual packages should be;
imaging said group of individual packages at said remote location to provide a remote electronic image suitable for further processing, said remote electronic image including some or all of said visual identifiers;
processing said remote electronic image to extract information from said some or all of said visual identifiers relating to the individual packages in said group to provide a remote Electronic Pick List; and
correlating said remote Electronic Pick List with said remote Pick List to provide information relating to the relationship between said group of individual packages and what ones of said group of individual packages should be.

19. The quality assurance method as defined in claim 18 wherein said information relating to the relationship between said group of individual packages and what ones of said group of individual packages should be is provided from said remote electronic image together with remarks relating thereto.

20. The quality assurance method as defined in claim 18 wherein said information relating to the relationship between said group of individual packages and what ones of said group of individual packages should be includes information relating to individual packages with no visual identifiers.

21. The quality assurance method as defined in claim 18 wherein said information relating to the relationship between said group of individual packages and what ones of said group of individual packages should be is provided from said remote electronic image together with marks relating thereto.

22. The quality assurance method as defined in claim 20 wherein said information relating to the relationship between said group of individual packages and what ones of said group of individual packages should be includes a mark indicating which of two or more individual packages in said group should be removed from said group.

23. A system comprising:
a container having a multiplicity of objects thereon, wherein at least one of said multiplicity of objects has an imagable identifier affixed thereto;
a container reader to image said multiplicity of objects to provide an image; and
an analyzer for determining, from said image and from a user-defined description of objects that were expected to be associated with said container, if said container has the expected objects.

24. The system according to claim 23 and wherein said user-defined description comprises at least one of the following: a pick list, a set of rules and a lookup table converting identification codes embodied in said identifiers to product terms.

25. The system according to claim 23 and wherein said analyzer comprises:
an image identification unit to generate an ID list of imagable identifiers in said image and at least of their coordinates in the image; and
a quality assurance analyzer to analyze said ID list against said user-defined description and to report errors, if any.

26. The system according to claim 23 and also comprising apparatus for marking said image to show the status of at least one or more of said identifiers which are errors.

27. The system according to claim 24 wherein said apparatus for marking said image to show the status of at least one or more of said identifiers which are errors marks the image for identifiers associated with said objects easiest to replace if less than all of similar objects are in error.

28. The system according to claim 23 and wherein said ID list comprises a multiplicity of records, one per identifier, and wherein each record comprises at least said identifier, and the coordinates of said identifier in said image.
